(19) United States
(12) Patent Application Publication
(10) Pub. No.: US 2011/0141525 A1
(43) Pub. Date: Jun. 16, 2011

(54) MULTI-LEVEL HALFTONE SCREENS

(76) Inventors: Yee S. Ng, Rochester, NY (US); Hwai-Tzuu Tai, Rochester, NY (US); Chung-Hui Kuo, Fairport, NY (US); Marnie Kan-Ng, (US)

(21) Appl. No.: 12/638,088

(22) Filed: Dec. 15, 2009

(51) Int. Cl. H04N 1/405

(52) U.S. Cl. 358/3.06

(57) ABSTRACT

The present invention relates to methods of improving color image quality by optimization of the gray level screens including blending a plurality of gray level screens to reducing the color grain noise and maintaining larger color gamut for the pictorial color imagery in the color printing systems that utilize gray level (multi-level) printing.

### FIELD OF THE INVENTION

The present invention relates to methods of printing. In particular, the present invention relates to methods of improving color image quality by optimization of gray level screens in color printing system utilizing gray level (multi-level) printing.

### BACKGROUND OF THE INVENTION

In electrostatographic imaging and recording processes such as electrographic reproduction, an electrographic reproduction apparatus is utilized to form an electrostatic latent image on a primary image-forming member such as a dielectric surface and is developed with a thermoplastic toner powder to form a visible image. The visible thermoplastic toner powder image is thereafter transferred to a receiver, e.g., a sheet of paper or plastic, and the visible thermoplastic toner powder image is subsequently fused to the receiver in a fusing station using heat or pressure, or both heat and pressure.

Most print engines and particularly electrophotographic print engines do not provide acceptable levels of gray for other images, such as photographs. Those skilled in the art have used halftone dots to emulate grayscale for reproducing images with continuous tones. One reason for this is that the particles used for forming the printed dots may be larger than is desirable even if the printing system were suited to printing very small binary pixels.

In the area of digital printing (the term “printing” is used to encompass both printing and displaying throughout), gray level has been achieved in a number of different ways. The representation of the intensity, i.e., the gray level, of a color by binary displays and printers has been the object of a variety of algorithms. Binary displays and printers are capable of making a mark, usually in the form of a dot, of a given, uniform size and at a specified resolution in marks per unit length, typically dots per inch. It has been well known to place the marks according to a variety of geometrical patterns such that a group of marks when seen by the eye give a rendition of an intermediate color tone between the color of the background (usually white paper stock) and total coverage, or solid density. The effect is such that a group of dots and dot-less blank spots, when seen by the eye, is a rendition of an intermediate color tone or density between the color of the initial paper stock, usually white, and total ink coverage, or solid density halftone dot. It is conventional to arrange the dots in rows, where the distance between rows is known as line spacing, and determines the number of lines per inch (lpi). In the ensuing paragraphs, discussions will be made in terms of white paper stock; it is understood that white paper stock is used as an illustration and not as a limitation of the invention and that other media may be used such as plastics, textiles, coated papers, metals, wood, edible articles, etc.

Continuous tone images contain an apparent continuum of gray levels. Some scenes, when viewed by humans, may require more than two hundred and fifty six discrete gray levels for each color to give the appearance of a continuum of gray levels from one shade to another. Halftone pictorial or graphical images lower the high contrast between the paper stock and toned image and thereby create a more visually pleasing image. As an approximation to continuous tone images, pictorial imagery has been represented via binary halftone technologies. In order to record or display a halftone image one picture element of the recording or display surface consists of a j×k matrix or cell of sub-elements where j and k are positive integers. A halftone image is reproduced by printing the respective sub-elements (pixels or pels) or leaving them blank, in other words, by suitably distributing the printed marks within each cell.

Another method of producing gray levels is provided by gray level printing. In such a method, each pixel has the capability to render several different dot sizes. In certain electrophotographic printing systems, for example, the dot size for a pixel is a function of the exposure time provided an LED element corresponding to that pixel. The longer the exposure time, the more toner is attracted to that particular pixel.

Some methods to create dot formations include U.S. Pat. No. 5,956,157, which discloses various dot type formations and the blending gray level dots of various dot types with a contrast index for different types of images in gray level printing. Also U.S. Pat. Nos. 7,218,420 and 7,450,269 describes the “3D halftone structure” that holds various dot screens of the multi-level halftoning process for the multi-level printer.

However, providing higher image quality with respect to line resolution and tone scales, gray level halftone presents its own dot rendering issues. Issues such as memory colors, graininess, color gamut, or screen texturing of the image quality attributes in color printing methods have not been previously addressed in the art. The present invention addresses some of these issues.

### SUMMARY OF THE INVENTION

The present invention relates methods of printing. In particular, the present invention relates to methods of improving color image quality by optimization of the gray level screens. Methods in accordance with the present invention include steps of blending a plurality of gray level screens to reducing the color grain noise and establishing a larger color gamut for the pictorial color imagery in color printing systems that utilizes a gray level (multi-level) printing.

The present invention contemplates blending various gray level screens such as FM, AM and contone screens according to color grain map analysis in one or multiple color separations and utilizes it in the graylevel color halftoning process for a graylevel color printing system, thereby improving print quality.

One embodiment of the instant invention contemplates a method of producing a color image that includes the steps of providing a plurality of gray level screens, providing pixel data, providing an aperiodic micrononuniformity map, using the aperiodic micrononuniformity map to determine an acceptable set gray level screens from the plurality of gray level screens, and blending multiple gray level screens from the acceptable set of gray level screens using the pixel data to form a blended gray level screen, and forming a color image using the blended gray level screen.

These and other aspects, objects, features and advantages of the present invention will be more clearly understood and appreciated from a review of the following detailed description of the preferred embodiments, the Figures, and appended claims.

### BRIEF DESCRIPTION OF THE DRAWINGS

FIG. 1A. illustrates exposure dots of a binary printer.

FIG. 1B. illustrates exposure dots of a multi-level printer.

FIG. 1C. illustrates a histogram of the digital contone CMYK data and the resulting histogram of the RTP data (also referred to as “multi-level halftone data”) after a multi-level halftone process has been performed.

FIG. 2A shows a block diagram of grain map color patches analysis.

FIG. 2B illustrates part of the color grain map encoded in LAB values.

FIG. 3 is a schematic side elevational view, in cross section, of a typical electrographic reproduction apparatus suitable for use with this invention;

FIG. 4 is a schematic side elevational view, in cross section, of the reprographic image-producing portion of the electrographic reproduction apparatus of FIG. 3, on an enlarged scale;

FIG. 5 is a schematic side elevational view, in cross section, of one printing module of the electrographic reproduction apparatus of FIG. 3, on an enlarged scale.

FIGS. 6A, 6B, 6C, and 6D show the blending algorithm flow.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the scope of the present invention. Before explaining the disclosed embodiments of the present invention in detail, it is to be understood that the invention is not limited in its application to the details of any particular arrangement shown, since the invention is capable of other embodiments. The terminology used herein is for the purpose of description and not of limitation. Further, although certain methods are described with reference to certain steps that are presented herein in certain order, in many instances, these steps may be performed in any order as would be appreciated by one skilled in the art, and the methods are not limited to the particular arrangement of steps disclosed herein.

The present invention provides methods of improving color image quality by optimization of the gray level screens including blending a plurality of gray level screens to reducing the color grain noise and maintaining larger color gamut for the pictorial color imagery in the color printing systems that utilize gray level (multi-level) printing. The color grain noise is aperiodic color micrononuniformity noise intrinsic in the color printing system that further caused by multiple color screens superposed on the color images.

For purposes of this invention an AM screen is a traditional graphic arts screening method used in offset printing in which the tone scale changes by varying the dot sizes in the halftone cell and it is called amplitude modulated screen. A contone screen is a screen that has no visible screen dots formed in the screen.

In the AM screening, the dot frequency is kept constant and dot size varies according to the tone values. In the offset CMYK color printing, the AM screen of each color is usually arranged in 0/15/45/75 degree orientation to avoid overprint artifacts. A FM screen, also referred to often as a frequency modulated screen, is a screen in which the tone changes by varying the numbers of the dots in the halftone cell. Each individual dot is a single pixel dot in the halftone cell. In the traditional FM screening, the dot size is kept constant and dot frequency varies according to the tone values. The FM screening is also called stochastic screening because the dots are randomly placed. A smooth FM screen is an improvement over the traditional FM screen to avoid unstable single dot size rendered and worm-like artifacts. The smooth FM screen is using larger dot sizes with varying dot frequency. It is visually smoother than the traditional FM screen and it is indicated in its power spectrum with smoother characteristics.

The traditional FM screen usually has larger color gamut than the traditional AM screen. The developed smooth FM screen has a measurable 1%˜2% volume gain than the traditional AM screen.

Also note that an aperiodic micro-nonuniformity is a microscale nonuniformity defect (or noise) resulted in the flat field of the halftone printing that appeared as grainy noise. The micro-nonuniformity and macro-nonuniformity are different. The granularity is classified as micro-nonuniformity. While streaking, banding, and mottle of the printing defects are classified as macro-nonuniformity. The nonuniformity artifacts may be appeared differently in different color areas. In addition an aperiodic micrononuniformity map is a map where there are objective measurement values (i.e.; granularity number) of the color variations of the printed color patches. The color patches are selected and organized in rows with the same hue but different lightness and saturations. The selected color patches covered certain memory colors such as blue sky, skin tone, green foliages, highlight colors, and etc.

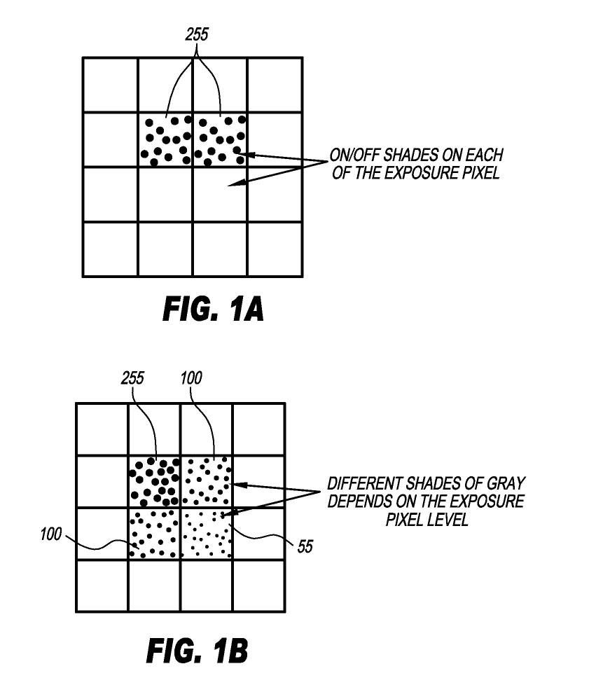

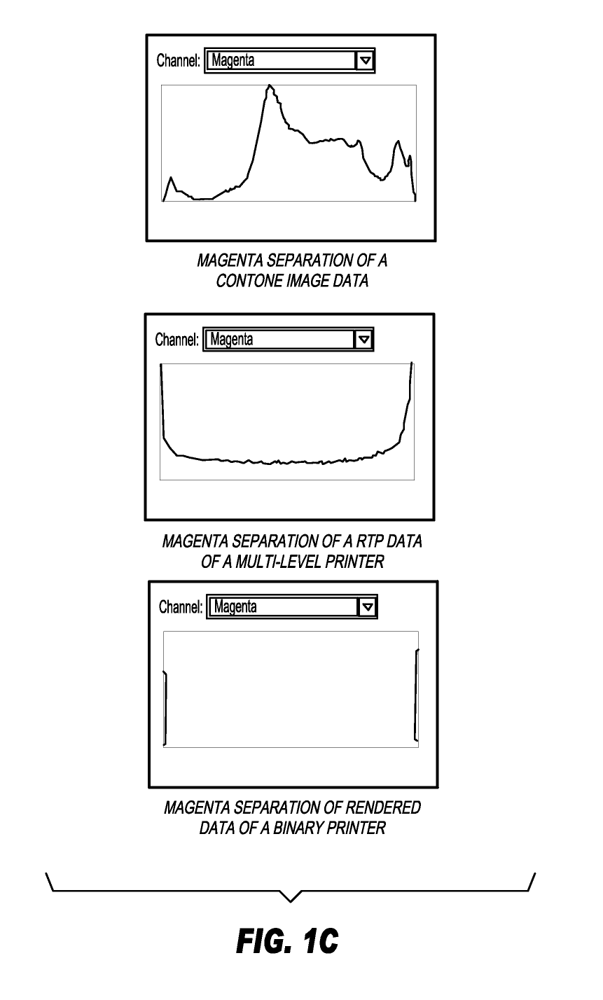

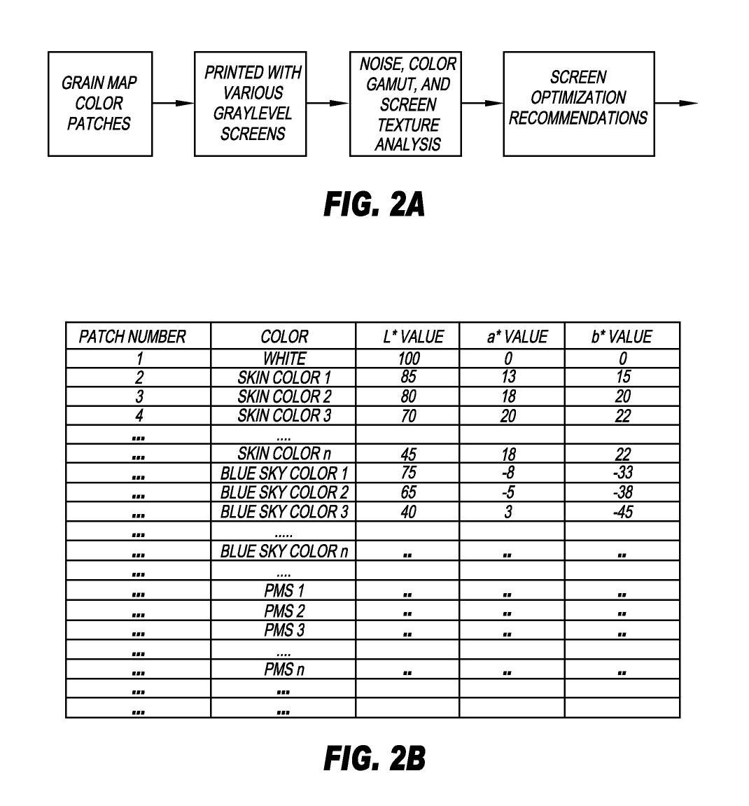

A multi-level printer (or a graylevel printer), as opposed to a binary printer, is able to print a single exposure dot having one of multiple intensities that resulted different tone density. For example, an 8-bit multi-level printer can print any one exposure dot with one of 256 different exposure levels. In contrast, a binary printer can either print a single exposure dot with one of two intensity values: “on” or “off.” In the halftoning process, the halftone cell may be organized with several pixels together to form a super pixel or a cell. Therefore, each halftone dot is formed in the cell with multiple exposure dots grouped together. Accordingly, the multi-level halftone process generates ready-to-print (RTP) data with exposure dots having one of a plurality of different exposure intensity levels (i.e, the graylevel values), depending upon the capabilities of its associated multi-level printer. FIG. 1A. illustrates exposure dots of a binary printer and FIG. 1B. illustrates exposure dots of a multi-level printer. FIG. 1C. illustrates a histogram of the digital contone CMYK data and the resulting histogram of the RTP data (also referred to as “multi-level halftone data”) after a multi-level halftone process has been performed. FIG. 1C illustrates an example of a one color histogram, a histogram of the one magenta color separation of the contone image and the rendered RTP data of a binary printer in comparison to a multi-level printer and a separation. The digital contone CMYK data is the original image data prior to halftone processing. The RTP data is ready to print image data that has been through halftone processing. Due to different halftoning processes, for example, binary halftoning process and multi-level halftoning process, the RTP data has total different distributions of data values between binary halftoning and multi-level halftoning.

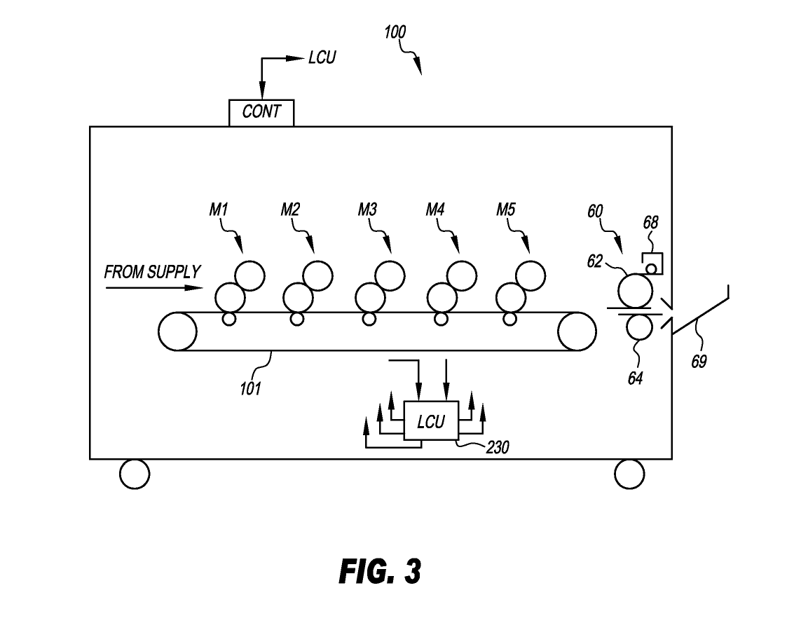

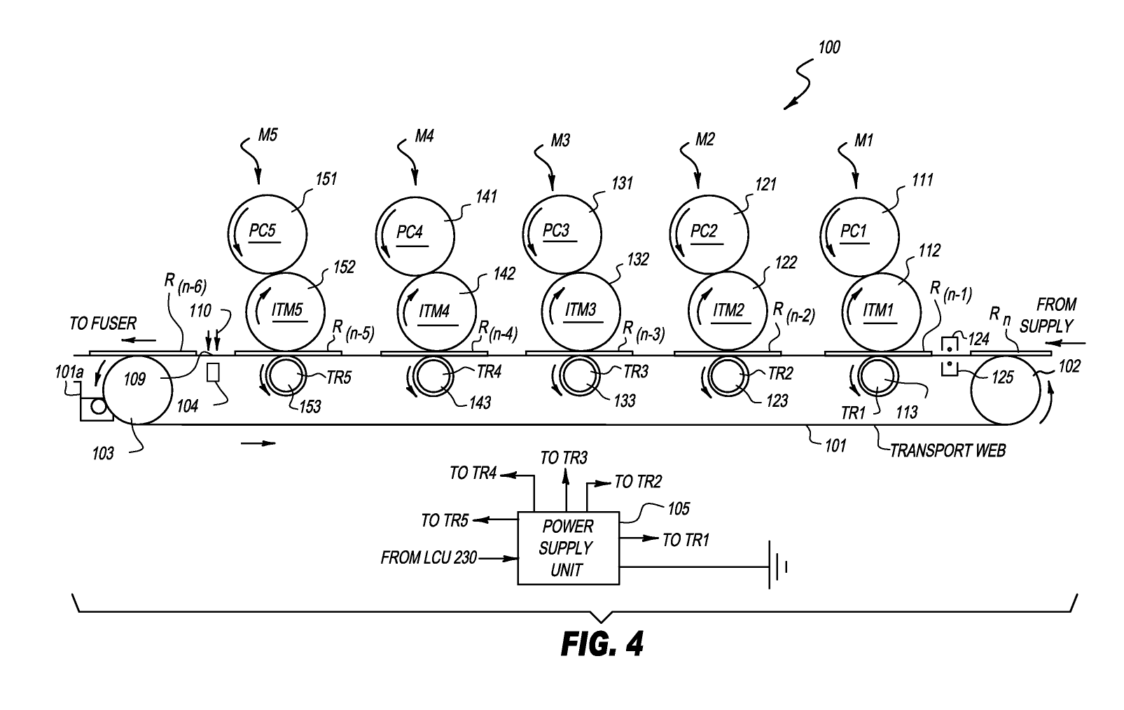

The color grain map is a collection of approximately one thousand special selected color patches of sizes ½″×½″ encoded in color independent color space Lab color values that are sparsely sampled across the whole Lab color space (with color management, these patches are mapped into various amount of colorant such as cyan/magenta/yellow/black of device colorant color space) and are arranged in an order from light tone/mid tone/dark tone. The selected color patches include some of the memory colors (such as skin tone, blue sky, green grass, etc.) for visual assessment and screen optimization. The color grain map is printed with various unique set of color screens on a multilevel printer. The grains (or micro-nonuniformity noise) of each patch can be objectively measured as a granularity number and also subjectively visualized as a graininess scale. The screen textures of different color screens can also be visually assessed from the color grain map analysis. FIG. 2A describes the block diagram of grain map color patches analysis. FIG. 2B illustrates part of the color grain map encoded in LAB values.

In order to produce pleasing images using AM screens, a set of AM screens are produced such that each screen is configured for one of the CMYK color separations, and the screens are superposed on their corresponding digital contone data at particular angles. Typically, when the screens are superposed, the cyan screen is oriented at 15 degrees over its corresponding digital contone data, the magenta screen is oriented at 75 degrees, the black screen is oriented at 45 degrees, and the yellow screen is oriented at zero degrees. When each of these screens are overlaid at these specific angles, their screen dots produce a pleasing microstructure called a rosette structure that the human eye does not readily notice as described in U.S. application Ser. No. 10/836,762 filed Apr. 30, 2004 which is hereby incorporated by reference. However, interference patterns of screen dots called moire patterns appear and occasionally degrade image quality when conventional AM screens are applied.

The stochastic screen is designed with random dots arranged in the image plane. There is no periodic structure or fixed screen frequency. One of the stochastic screen type is frequency modulated (FM) screen. It has been used in the field with most of inkjet printing devices. Those stochastic screens do not have the problems associated with the distracting moire interference pattern. However, worm-like artifacts can be generated when using stochastic screens due to connections between screen dots in higher parts of the tone scale, i.e. parts of the tone scale where exposure intensity is high and screen dots are large and begin to join.

A contone (CT) screen is a unique screen in multi-level printing in that there are no screen dots or screen structures are formed. This kind of screen can not be formed in a binary printer in general. It is an unique screen design in the graylevel printing. Therefore, the present invention will not be applicable to the binary printing system.

Each screen type has their unique characteristics: visual graininess, color gamut, visual overprinting screen structure. This invention disclosed how to best utilize their unique characteristics to create a composite screen set that optimize the image quality.

In the graininess map study that we have studied and analyzed the data showed that for some of the most important memory colors (such as skin tone and blue sky), magenta color has the largest impact on graininess (especially with UCR (under color removal) when little black separation is involved). From the study of color gamut on traditional AM screen, Smooth FM screen and Contone screen, it is observed that Smooth FM screen can have 1%˜2% gain in color gamut with respect to traditional AM screen. Contone screen can have ˜5% increase in color gamut compared with traditional AM screen. Most of the gamut gain is in the mid-tone where the dot gain effect is most prominent. From a visual graininess viewpoint, Contone screen at higher coverage (say >50%) is actually quite good. In fact it has far less screen structure than traditional AM screen. However Contone screen is grainy in the toe region (lower % coverage) compared with traditional AM screen. If a traditional AM like screen is used in the toe region and contone like screen is used in the region from below mid-tone and up, then one can potentially get stable dots in the toe (less grain), larger gamut in the mid tone and lower moire texture in the higher % dot (or shadow area). Further, in order to reduce grain in the toe, perhaps one can maintain a larger dot size and vary the screen frequency (like a Smooth FM screen).

Whether to use either a (1) variable frequency (larger dot) structure, that merges into a traditional AM, such as fixed screen structure, then merges to contone structure, or (2) a traditional AM like fixed screen structure used to be merged into a contone structure, is determined by printing and evaluating the final printed result in order to optimize based on one or more of gamut size gain, reduction of graininess over the whole gamut and important memory colors (skin tone, blue sky, etc). In one embodiment one graininess map is used for the whole gamut and color IT8 standardized target as test guide to tune the color gamut size and image graininess together with subjective test prints that has human faces and blue sky scene. Of course, the variable structure multi-level halftone can be applied towards more than one color separation. It is further pointed out that, for different applications, such as photo-rich applications, one may have application specific screening package (that include not just screens, but perhaps color preferences for certain memory colors such as skin tone, blue sky, etc., basically the photographic look can be different than the graphic arts look). Of course as further in that direction, a customer selected preference set (with a set of prints with feedback from customers on selected region of the images) perhaps can be made and is more desirable than a default set.

The transition of variable dot center structures into fixed dot center structures or the fixed dot center structure to contone screen of no screen structure is critical, the design must be carefully tuned to blend and mash two different structures naturally. Human vision is very sensitive to any abrupt change of the screen structures.

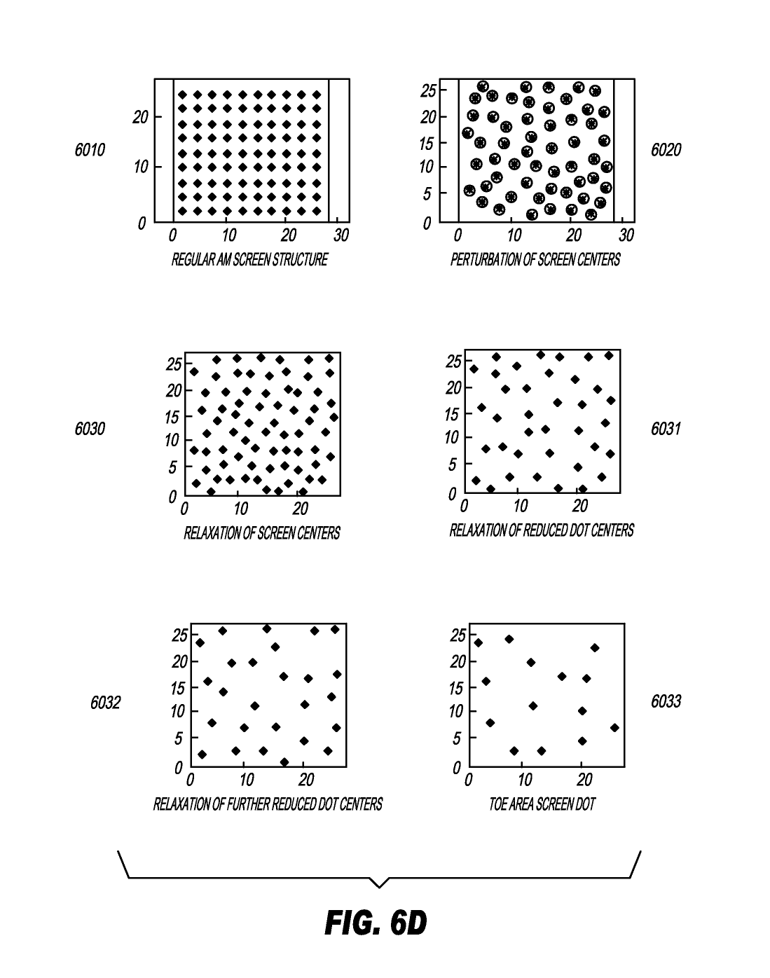

FIGS. 6A, 6B, 6C, and 6D show a portion of the printing method of the current invention, including blending algorithm flow for the method for producing pleasing color images using an optimized gray level screen. FIG. 6A, describes the process steps of tuning stochastic dots to a lower frequency in the tone scale range provided by the grain map analysis results. To make sure the transition to be smooth between FM and AM screen structure, the FM screen starts with identical dot centers of AM screen and reduce the number of dot centers step by step gradually on a controlled dot selection process. This is then coupled with the randomization and relaxation of dot centers process to build the FM dots in the blended dot building process. A pleasing color image results when the FM dots are blend-in with the AM screen structure with smooth transition can then be built with assurance. This tuning of stochastic screen dots process is also illustrated graphically in FIG. 6D. The blending of multiple gray level screens of the present invention is further illustrated in FIG. 6B and FIG. 6C as discussed in detail below.

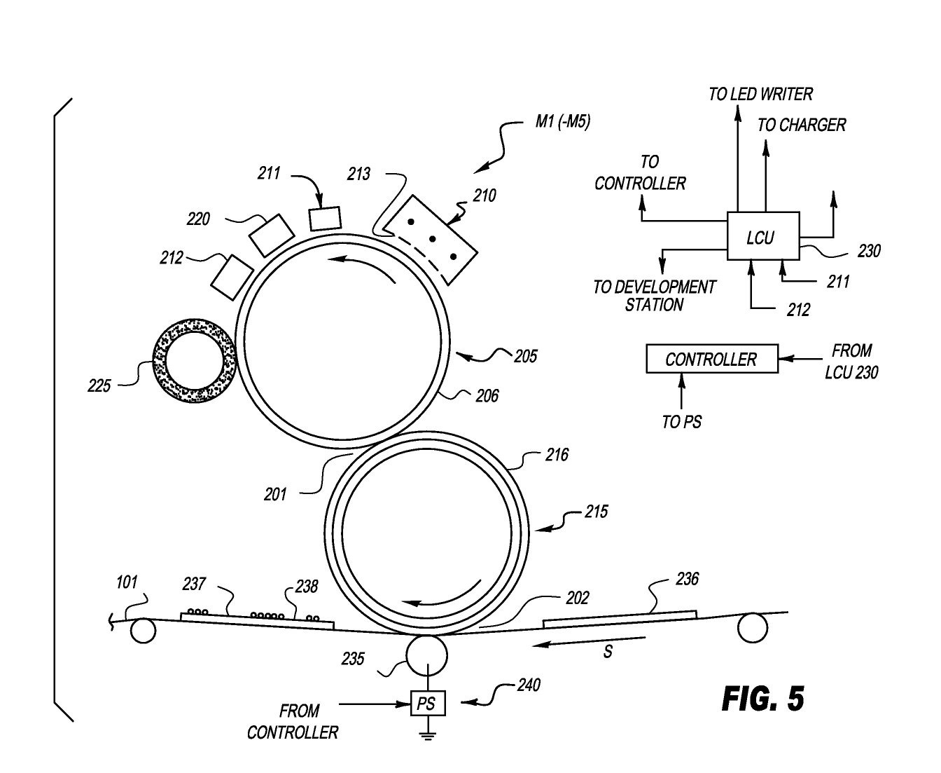

FIGS. 3-5 show schematic side elevational views of portions of a typical electrographic print engine or printer apparatus suitable for printing of pentachrome images. Although one embodiment of the invention involves printing using an electrophotographic engine having five sets of single color image producing or printing stations or modules arranged in tandem, the invention contemplates that more or less than five colors may be combined on a single receiver member, or may include other typical electrographic writers or printer apparatus and this process could be adapted to mono-component printers as well as mono-color printers.

An electrographic printer apparatus 100 has a number of tandemly arranged electrostatographic image forming printing modules M1, M2, M3, M4, and M5. Each of the printing modules generates a single-color toner image for transfer to a receiver member successively moved through the modules. Each receiver member, during a single pass through the five modules, can have transferred in registration thereto up to five single-color toner images to form a pentachrome image.

As used herein the term pentachrome implies that in an image formed on a receiver member combinations of subsets of the five colors are combined to form other colors on the receiver member at various locations on the receiver member, and that all five colors participate to form process colors in at least some of the subsets wherein each of the five colors may be combined with one or more of the other colors at a particular location on the receiver member to form a color different than the specific color toners combined at that location.

In a particular embodiment, printing module M1 forms black (K) toner color separation images, M2 forms yellow (Y) toner color separation images, M3 forms magenta (M) toner color separation images, and M4 forms cyan (C) toner color separation images. Printing module M5 may form a red, blue, green or other fifth color separation image. It is well known that the four primary colors cyan, magenta, yellow, and black may be combined in various combinations of subsets thereof to form a representative spectrum of colors and having a respective gamut or range dependent upon the materials used and process used for forming the colors. However, in the electrographic printer apparatus, a fifth color can be added to improve the color gamut. In addition to adding to the color gamut, the fifth color may also be used as a specialty color toner image, such as for making proprietary logos, or a clear toner for image protective purposes.

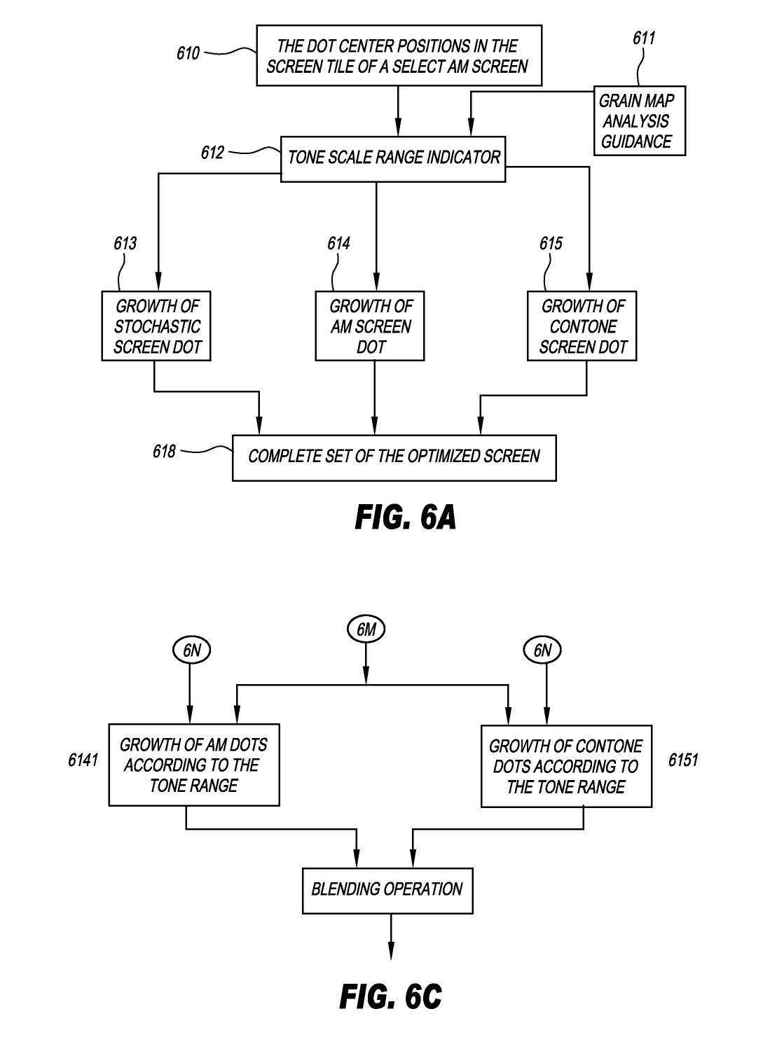

Receiver members (Rn-R₍ₙ₋₆₎ as shown in FIG. 4) are delivered from a paper supply unit (not shown) and transported through the printing modules M1-M5. The receiver members are adhered (e.g., preferably electrostatically via coupled corona tack-down chargers 124, 125) to an endless transport web 101 entrained and driven about rollers 102, 103. Each of the printing modules M1-M5 similarly includes a photoconductive imaging roller, an intermediate transfer member roller, and a transfer backup roller. Thus in printing module M1, a black color toner separation image can be created on the photoconductive imaging roller PC1 (111), transferred to intermediate transfer member roller ITM1 (112), and transferred again to a receiver member moving through a transfer station, which transfer station includes ITM1 forming a pressure nip with a transfer backup roller TR1 (113).

Similarly, printing modules M2, M3, M4, and M5 include, respectively: PC2, ITM2, TR2 (121, 122, 123); PC3, ITM3, TR3 (131, 132, 133); PC4, ITM4, TR4 (141, 142, 143); and PC5, ITM5, TR5 (151, 152, 153). A receiver member, Rₙ, arriving from the supply, is shown passing over roller 102 for subsequent entry into the transfer station of the first printing module, M1, in which the preceding receiver member R₍ₙ₋₁₎ is shown. Similarly, receiver members R₍ₙ₋₂₎, R₍ₙ₋₃₎, R₍ₙ₋₄₎, and R₍ₙ₋₅₎ are shown moving respectively through the transfer stations of printing modules M2, M3, M4, and M5. An unfused image formed on receiver member R₍ₙ₋₆₎ is moving as shown towards a fuser of any well known construction, such as the fuser assembly 60 (shown in FIG. 3).

A power supply unit 105 provides individual transfer currents to the transfer backup rollers TR1, TR2, TR3, TR4, and TR5 respectively. A logic and control unit 230 (FIG. 3) includes one or more computers and in response to signals from various sensors associated with the electrophotographic printer apparatus 100 provides timing and control signals to the respective components to provide control of the various components and process control parameters of the apparatus in accordance with well understood and known employments. A cleaning station 101a for transport web 101 is also typically provided to allow continued reuse thereof.

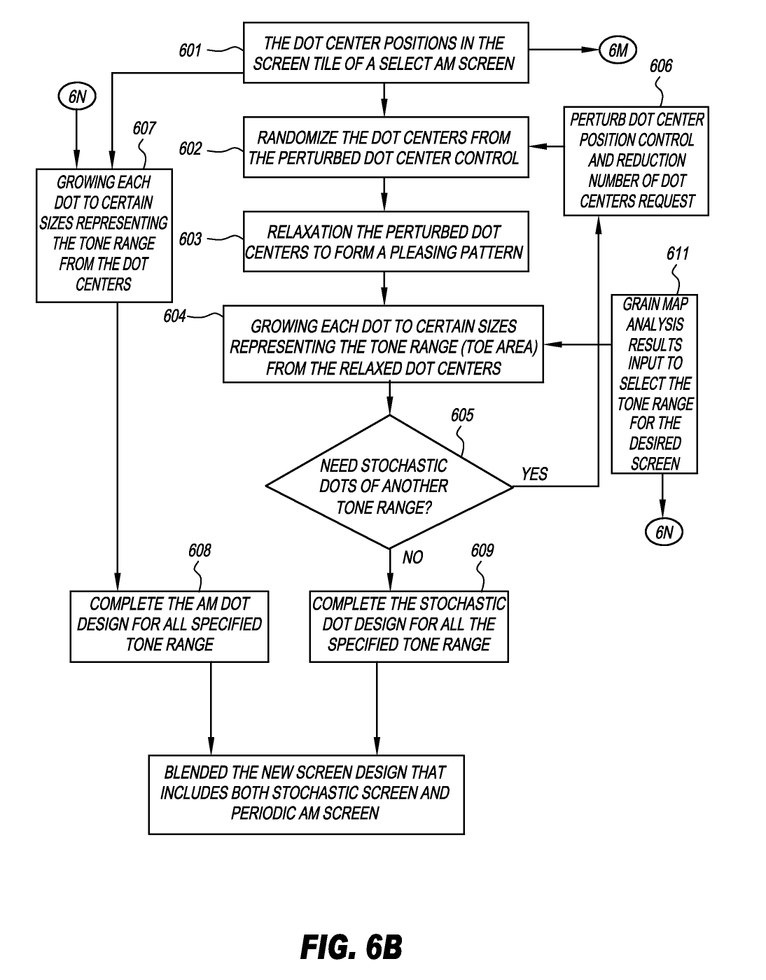

With reference to FIG. 5 wherein a representative printing module (e.g., M1 of M1-M5) is shown, each printing module of the electrographic printer apparatus 100 includes a plurality of electrographic imaging subsystems for producing a single color toned image. Included in each printing module is a primary charging subsystem 210 for uniformly electrostatically charging a surface 206 of a photoconductive imaging member (shown in the form of an imaging cylinder 205). An exposure subsystem 220 is provided for image-wise modulating the uniform electrostatic charge by exposing the photoconductive imaging member to form a latent electrostatic color separation image of the respective color.

A development station subsystem 225 serves for toning the image-wise exposed photoconductive imaging member with toner of a respective color. An intermediate transfer member 215 is provided for transferring the respective color separation image from the photoconductive imaging member through a transfer nip 201 to the surface 216 of the intermediate transfer member 215 and from the intermediate transfer member 215 to a receiver member (receiver member 236 shown prior to entry into the transfer nip and receiver member 237 the respective toned color separation images in superposition to form a composite multicolor image thereon.

Subsequent to transfer of the respective color separation images, overlaid in registration, one from each of the respective printing modules M1-M5, the receiver member is advanced to a fusing assembly to fuse the multicolor toner image to the receiver member. Additional necessary components provided for control may be assembled about the various process elements of the respective printing modules (e.g., a meter 211 for measuring the uniform electrostatic charge, a meter 212 for measuring the post-exposure surface potential within a patch area of a patch latent image formed from time to time in a non-image area on surface 206, etc). Further details regarding the electrographic printer apparatus 100 are provided in U.S. Publication No. 2006/0133870, published on Jun. 22, 2006, in the name of Yee S. Ng et al.

Associated with the printing modules 200 is a main printer apparatus logic and control unit (LCU) 230, which receives input signals from the various sensors associated with the printer apparatus and sends control signals to the chargers 210, the exposure subsystem 220 (e.g., LED writers), and the development stations 225 of the printing modules M1-M5. Each printing module may also have its own respective controller coupled to the printer apparatus main LCU 230.

Subsequent to the transfer of the five color toner separation images in superposed relationship to each receiver member, the receiver member is then serially de-tacked from transport web 101 and sent in a direction to the fusing assembly 60 to fuse or fix the dry toner images to the receiver member. The transport web is then reconditioned for reuse by cleaning and providing charge to both surfaces 124, 125 (see FIG. 4) which neutralizes charge on the opposed surfaces of the transport web 101.

The electrostatic image is developed by application of pigmented marking particles (toner) to the latent image bearing photoconductive drum by the respective development station 225. Each of the development stations of the respective printing modules M1-M5 is electrically biased by a suitable respective voltage to develop the respective latent image, which voltage may be supplied by a power supply or by individual power supplies (not illustrated). Preferably, the respective developer is a two-component developer that includes toner marking particles and magnetic carrier particles.

Each color development station has a particular color of pigmented toner marking particles associated respectively therewith for toning. Thus, each of the five modules creates a different color marking particle image on the respective photoconductive drum. As will be discussed further below, a non-pigmented (i.e., clear) toner development station may be substituted for one of the pigmented developer stations so as to operate in similar manner to that of the other printing modules, which deposit pigmented toner. The development station of the clear toner printing module has toner particles associated respectively therewith that are similar to the toner marking particles of the color development stations but without the pigmented material incorporated within the toner binder.

With further reference to FIG. 3, transport belt 101 transports the toner image carrying receiver members to a fusing or fixing assembly 60, which fixes the toner particles to the respective receiver members by the application of heat and pressure. More particularly, fusing assembly 60 includes a heated fusing roller 62 and an opposing pressure roller 64 that form a fusing nip there between. Fusing assembly 60 also includes a release fluid application substation generally designated 68 that applies release fluid, such as, for example, silicone oil, to fusing roller 62. The receiver members carrying the fused image are transported seriatim from the fusing assembly 60 along a path to either a remote output tray, or is returned to the image forming apparatus to create an image on the backside of the receiver member (form a duplex print) for the purpose to be described below.

The logic and control unit (LCU) 230 includes a microprocessor incorporating suitable look-up tables and control software, which is executable by the LCU 230. The control software is preferably stored in memory associated with the LCU 230. Sensors associated with the fusing assembly provide appropriate signals to the LCU 230. In response to the sensors, the LCU 230 issues command and control signals that adjust the heat and/or pressure within fusing nip 66 and otherwise generally nominalizes and/or optimizes the operating parameters of fusing assembly 60 for imaging substrates.

The LCU can include, in one embodiment, a processor operative to process the color separation image data or mono-color image data in accordance with first and second or more halftone screen processings at different screen angles and combining the results of the processings to generate composite image data of the first and second or more halftone screen processings. This processor is operative to process the color separation image data or mono-color image data in accordance with a dot structure dot growth pattern processing including forming composite image data for generating a color separation or mono-color image as a rosette and with a line structure dot growth pattern processing and the apparatus includes a printer responsive to the composite image data for generating a color separation image or mono-color image having a diamond structure. Alternatively the processor is operative to process the color separation image data of the one color in accordance with a dot structure dot growth pattern processing.

Image data for writing by the printer apparatus 100 may be processed by a raster image processor (RIP), which may include a color separation screen generator or generators. The output of the RIP may be stored in frame or line buffers for transmission of the color separation print data to each of respective LED writers K, Y, M, C, and R (which stand for black, yellow, magenta, cyan, and red respectively and assuming that the fifth color is red). The RIP and/or color separation screen generator may be a part of the printer apparatus or remote therefrom. Image data processed by the RIP may be obtained from a color document scanner or a digital camera or generated by a computer or from a memory or network which typically includes image data representing a continuous image that needs to be reprocessed into halftone image data in order to be adequately represented by the printer.

The RIP may perform image processing processes including color correction, etc. in order to obtain the desired color print. Color image data is separated into the respective colors and converted by the RIP to halftone dot image data in the respective color using matrices, which comprise desired screen angles and screen rulings. The RIP may be a suitably programmed computer and/or logic devices and is adapted to employ stored or generated matrices and templates for processing separated color image data into rendered image data in the form of halftone information suitable for printing.

The method can, in one embodiment, further include processing a color separation image data for each of two or more different colors and generating the acceptable set gray level screens from the plurality of gray level screens for each of the two colors and wherein the two colors are complementary colors to each other. These two or more colors can also be each processed in accordance with two or more halftone screen processings at different screen angles. in one embodiment, for example, processing the color separation image data or mono-color image data in accordance with first and second or more halftone screen processings at different screen angles and obtaining results of the processings and then combining the results of the processings to generate composite image data of the first and second or more halftone screen processings. The color separation image data or mono-color image data can be processed in accordance with a dot structure dot growth pattern processing including printing the composite image data and generating a color separation or mono-color image as a rosette. Also the color separation or mono-color image data can be processed in accordance with the first and the second and a third halftone screen processing all at different screen angles or in accordance with the first and second halftone screen processings and with a line structure dot growth pattern processing and in response to the composite image data generating a color separation or mono-color image having a diamond structure.

FIGS. 6A, 6B, and 6C illustrate one embodiment of screen blending algorithm flow. FIG. 6A, describes the block diagram of a complete screen design process for the whole tone scale range. The complete screen design process is guided by the results of grain map analysis 611 to select the tone scale ranges 612 for the subsequent screen design and screen blending in their transition area. For example, the results of the grain map analysis have indicated that in the tone range 0% to 5% is suitable for the stochastic screen (FM) and selects 5% to 10% tone range for FM screen to AM screen transition zone. The AM screen is suitable in the tone range 10% to 60% and selects 60% to 70% tone range for AM screen to contone screen transition zone. The contone screen is then applied in the 70% to 100% tone range. The result of grain map analysis 611 determines the tone range selection. The dot blending process makes sure there are smooth transitions between screens.

Since dot structure of FM screen, AM screen, and contone screen are different, each dot grows independently according to its own dot building process as 613, 614, 615 of FIG. 6A in their specific tone scale range. Each screen is then combined with their blending process to smooth transitions between screens and complete the screen design. FIG. 6B and FIG. 6C describes their subsequent screen blending process.

FIG. 6B describes the process steps of tuning stochastic dots to a lower FM screen frequency in the tone scale range provided by the grain map analysis results. FIG. 6D illustrates the states of dot centers according to the FIG. 6B process, starting at step in 601 of FIG. 6B, with multiple dot centers of a desirable AM screen as illustrated in 6010 of FIG. 6D. Each positions of dot center are perturbed in 602 with a controlled range. The dot centers become randomly placed as illustrated in 6020 of FIG. 6D. The random placed centers are processed through relaxation step 603 to have more pleasing pattern formed as illustrated in 6030 of FIG. 6D. At this point the pattern still has a random dot center nature. Each dot is then growing to a certain dot size 604 according to the tone scale from the relaxed dot center. The 606 controls the dot center perturbation and total number of dot centers in the cell at each iteration 605 and continues with each 602,603,604 steps.

This process generated stochastic dots with controlled FM screen frequency range in the desired tone range as illustrated in 6031,6032,6033 of FIG. 6D. The AM screen dots are built with dot growing process 607 to a certain size according to its tone required. The dots 608, 609 are then built with carefully blending FM screen and AM screen together in a controlled way. A pleasing FM dots that blend-in with the AM screen structure with smooth transition can then be built with assurance to create an optimized gray level screens necessary to produce a final pleasing image.

FIG. 6C illustrates the dot building process of AM screen 6141 and contone screen 6151 in their screen transition zone. The result of grain map analysis 611 determines the transition zone in the tone scale.

The invention has been described in detail with particular reference to certain preferred embodiments thereof, but it will be understood that variations and modifications can be effected within the spirit and scope of the invention.

What is claimed is:

1. A method of printing comprising:
providing a plurality of gray level screens;
providing pixel data;
providing an aperiodic micrononuniformity map;
using the aperiodic micrononuniformity map to determine an acceptable set gray level screens from the plurality of gray level screens; and
blending multiple gray level screens from the acceptable set of gray level screens using the pixel data to form a blended gray level screen; and
forming a color image using the blended gray level screen set.

2. The method of claim 1, wherein the acceptable set of gray level screens includes an AM screen, an FM screen, and a contone screen.

3. The method of claim 2, wherein the FM screen has a lower screen frequency than the AM screen.

4. The method of claim 1, wherein the acceptable set of gray level screens is based on a tone scale percentage of the pixel data.

5. The method of claim 2, wherein a blended gray level screen level screen is generated such that the FM screen has dot centers similar to those of the AM screen in the beginning and then are gradually reduced to a lower frequency.

6. The method of claim 5, wherein the FM screen is designed in the highlight area and the contone screen is designed in the midtone-to-shadow area.

7. The method of claim 1 further comprising:
processing the color separation image data of each of two different colors and generating the acceptable set gray level screens from the plurality of gray level screens for each of the two colors.

8. The method of claim 7 wherein at least two colors are complementary colors to each other.

9. The method of claim 7 wherein the two different colors are each processed in accordance with two or more halftone screen processings at different screen angles.

10. The method of claim 1, the method further comprising:
processing the color separation image data or mono-color image data in accordance with first and second or more halftone screen processings at different screen angles and obtaining results of the processings; and
combining the results of the processings to generate composite image data of the first and second or more halftone screen processings.

11. The method of claim 10 wherein the color separation image data or mono-color image data is processed in accordance with a dot structure dot growth pattern processing.

12. The method of claim 11 including printing the composite image data and generating a color separation or mono-color image as a rosette.

13. The method of claim 11 wherein the color separation or mono-color image data is processed in accordance with the first and the second and a third halftone screen processing all at different screen angles.

14. The method of claim 13 wherein the image color separation or mono-color image data is processed in accordance with the first and second halftone screen processings and with a line structure dot growth pattern processing and in response to the composite image data generating a color separation or mono-color image having a diamond structure.

15. An apparatus for processing image data representing a color separation or mono-color image, the apparatus comprising:
a processor operative to process the color separation image data or mono-color image data in accordance with first and second or more halftone screen processings at different screen angles and combining the results of the processings to generate composite image data of the first and second or more halftone screen processings.

16. The apparatus of claim 15 wherein the processor is operative to process the color separation image data or mono-color image data in accordance with a dot structure dot growth pattern processing.

17. The apparatus of claim 15 including a printer responsive to the composite image data for generating a color separation or mono-color image.

18. The apparatus of claim 15 wherein the processor is operative to process the color separation image data or mono-color image data in accordance with a line structure dot growth pattern processing and the apparatus includes a printer responsive to the composite image data for generating a color separation image or mono-color image having a diamond structure.

19. The apparatus of claim 18 wherein the processor is operative to process the color separation image data of the one color in accordance with a dot structure dot growth pattern processing.

20. The apparatus of claim 15 including a printer responsive to the composite image data for generating a color separation or mono-color image as a rosette.
